(19) United States
(12) Patent Application Publication
(10) Pub. No.: US 2003/0170430 A1
(43) Pub. Date: Sep. 11, 2003

(54) Bio-wave device including bio-wave card and sticky

(76) Inventor: Ren-Sheng Ou, Taichung (TW)

Correspondence Address: Ren-Sheng Ou, 58, MA YUAN WEST ST., TAICHUNG, TW

(21) Appl. No.: 10/444,725

(22) Filed: May 22, 2003

Related U.S. Application Data
(63) Continuation-in-part of application No. 09/841,118, filed on Apr. 24, 2001.

(51) Int. Cl. B32B 33/00

(52) U.S. Cl. 428/195.1; 428/537.5

(57) ABSTRACT

A bio-wave device includes a base member, and a layer of bio-wave material attached on the surface of the base member and having a pre-determined shape. Thus, the bio-wave device that can produce multiple bio-waves through the layer of bio-wave material, so that when the multiple bio-waves coincide with and overlap the natural frequency of the human cell organism, the resonance absorbing effect is thus produced, so as to enhance immunity of the human body.

### CROSS-REFERENCES TO RELATED APPLICATIONS

The present invention is a continuation-in-part application of the co-pending U.S. Ser. No. 09/841,118, filed on Apr. 24, 2001.

### BACKGROUND OF THE INVENTION

1. Field of the Invention

The present invention relates to a bio-wave device including a bio-wave card and sticky piece, and more particularly to a portable bio-wave device that can enhance immunity of the human body.

2. Description of the Related Art

According to the medical research, the human skin is a complex nervous transmission unit distributed uniformly in the whole body to function as a message transmitter and a message decoder. The brain is a bio-electronic network. By transmitting messages, the brain can convert the messages into energy of any form. The energy of the bio-wave can be amplified by electronic equipment to function as signals for research. Thus, the energy of the bio-wave is available for the health products, including tight underwear, eye masks, skin protective glue, etc.

### SUMMARY OF THE INVENTION

The primary objective of the present invention is to provide a bio-wave device that can produce multiple bio-waves through the layer of bio-wave material, so that when the multiple bio-waves coincide with and overlap the natural frequency of the human cell organism, the resonance absorbing effect is thus produced, so as to enhance immunity of the human body.

Another objective of the present invention is to provide a bio-wave device including a sticky piece that can be attached on the user's ache portion, so as to enhance immunity of the human body, and to promote the circulation of blood.

A further objective of the present invention is to provide a bio-wave device, wherein the chlorine contained in the water is decomposed by the bio-wave material contained in the bio-wave device, so as to decrease the harmful gas and to activate the water quality.

In accordance with the present invention, there is provided a bio-wave device, comprising:

a base member; and

a layer of bio-wave material attached on a surface of the base member and having a pre-determined shape.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of the bio-wave device in accordance with the first embodiment of the present invention;

FIG. 2 is a perspective view of the bio-wave device in accordance with the second embodiment of the present invention;

FIG. 3 is a plan view of the bio-wave device in accordance with one embodiment of the present invention;

FIG. 4 is a plan view of the bio-wave device in accordance with another embodiment of the present invention;

FIG. 5 is a plan view of the bio-wave device in accordance with a further embodiment of the present invention;

FIG. 6 is a perspective view of the bio-wave device in accordance with the third embodiment of the present invention;

FIG. 7 is a schematic operational view of the bio-wave device in accordance with the present invention;

FIG. 8 is a schematic operational view of the bio-wave device in accordance with the present invention; and

FIG. 9 is a schematic operational view of the bio-wave device in accordance with the present invention.

### DETAILED DESCRIPTION OF THE INVENTION

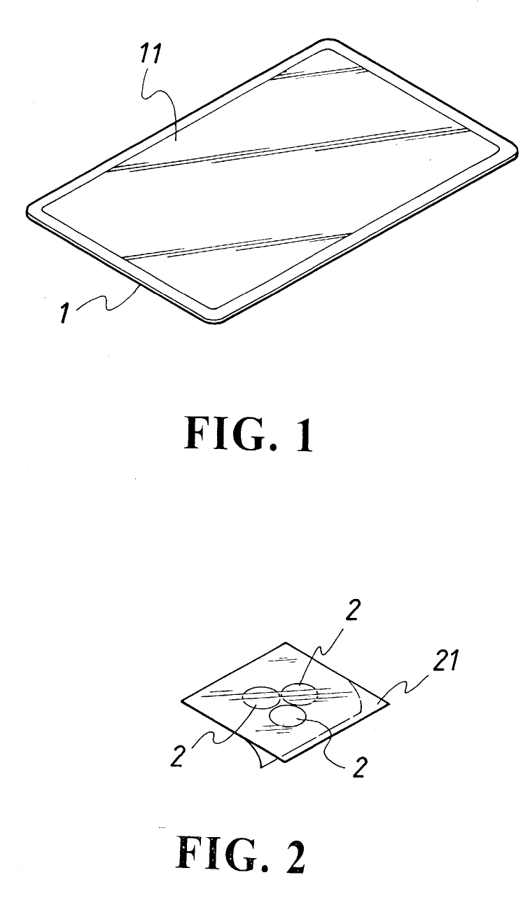

Referring to the drawings and initially to FIG. 1, a bio-wave device in accordance with the preferred embodiment of the present invention comprises a base member, and a layer of bio-wave material adhered or bonded on the base member. Preferably, the layer of bio-wave material is adhered or bonded on the base member by a laser technology. In addition, the layer of bio-wave material is made of a powdered or liquid element at least containing Ca, Ti, Cr, Ni, Cu, Pb, Mn, Fe, Zn, etc. Further, the layer of bio-wave material has a pre-determined shape.

In practice, the base member includes a hard card 1. The layer of bio-wave material includes a thin layer 11 adhered or bonded on a surface of the hard card 1 by the laser technology. The thin layer 11 is made of a powdered or liquid element at least containing Ca, Ti, Cr, Co, Ni, Cu, Pb, Mn, Fe, Zn, etc. The thin layer 11 has a pre-determined shape. Preferably, the thin layer 11 has a rectangular shape.

In such a manner, the bio-wave device can produce multiple bio-waves through the layer of bio-wave material. When the multiple bio-waves coincide with and overlap the natural frequency of the human cell organism, a resonance absorbing effect is thus produced, so as to enhance immunity of the human body.

Referring to FIG. 2, the base member includes a plurality of soft sticky pieces 2, and the layer of bio-wave material is adhered or bonded on a surface of each of the sticky pieces 2 by the laser technology. In addition, the bio-wave device further comprises a protective film 21 removably mounted on the sticky pieces 2 to protect the sticky pieces 2. Thus, the protective film 21 can be removed when the sticky pieces 2 are used.

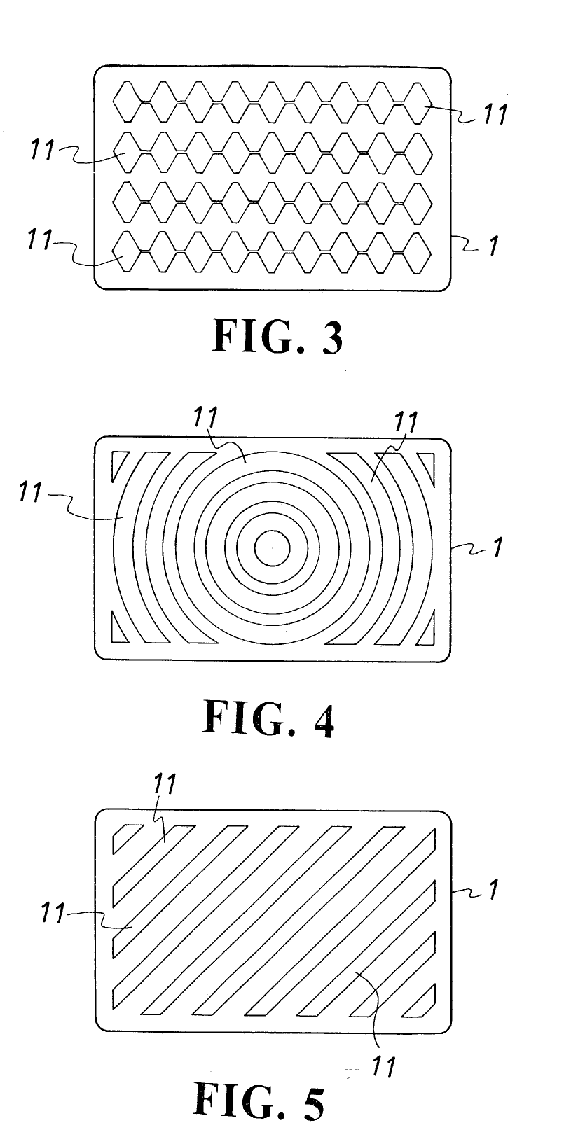

As shown in FIG. 3, the pre-determined shape of the layer of bio-wave material (the thin layer 11) includes a plurality of discrete, spaced apart sections.

As shown in FIG. 4, the pre-determined shape of the layer of bio-wave material (the thin layer 11) includes a central portion and a plurality of spaced apart, arcuate strips around the central portion.

As shown in FIG. 5, the pre-determined shape of the layer of bio-wave material (the thin layer 11) includes a plurality of spaced apart, diagonal strips.

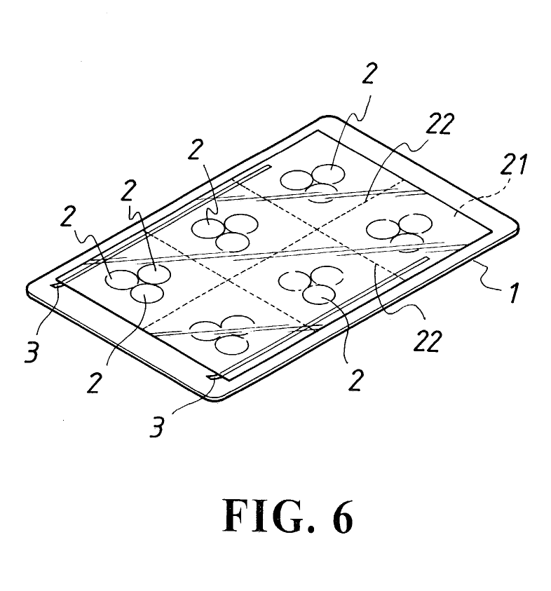

Referring to FIG. 6, the base member includes a hard card 1, and a plurality of soft sticky pieces 2 removably attached to the hard card 1. In addition, the bio-wave device further comprises a pulling tab 3 located between the hard card 1 and the sticky pieces 2 to facilitate removable of the sticky pieces 2 from the hard card 1. In such a manner, the pulling tab 3 can be pulled away to detach the sticky pieces 2 from the hard card 1, so that the sticky pieces 2 can be torn away easily and rapidly. Further, the bio-wave device further comprises a plurality of separable lines 22 formed between the sticky pieces 2, so that the sticky pieces 2 can be torn away one by one.

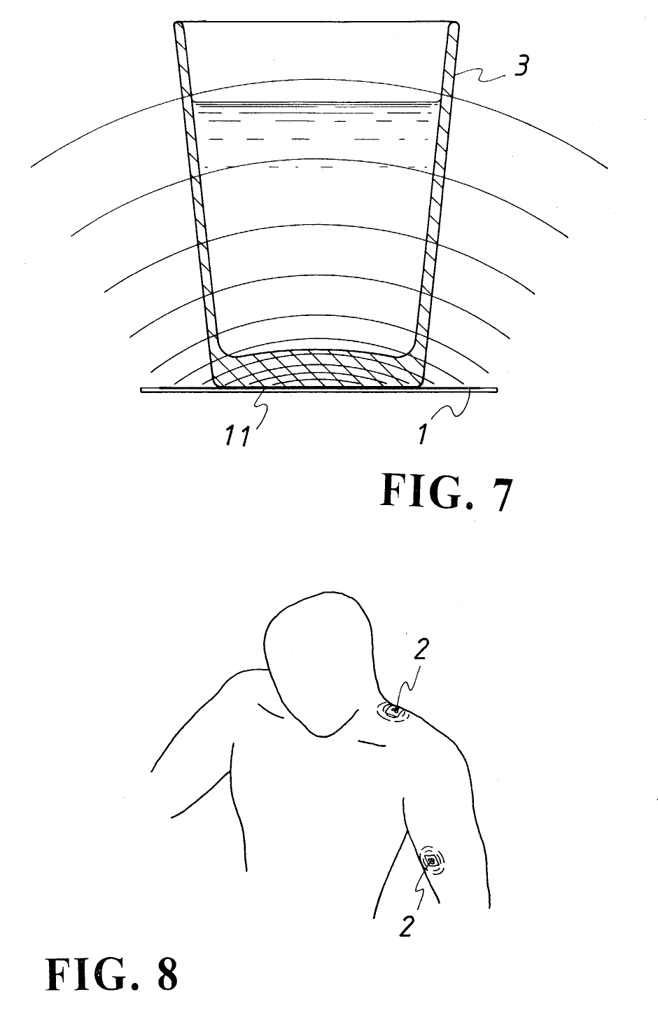

As shown in FIG. 7, in use of the bio-wave device, a water cup 3 is placed on the hard card 1, with the bottom of the water cup 3 being rested on the thin layer 11. Thus, the chlorine contained in the water is decomposed by the bio-wave material contained in the thin layer 1, so as to decrease the harmful gas and to activate the water quality. In addition, the bio-wave device can be used to reduce the nicotine and tar contained in the cigarette.

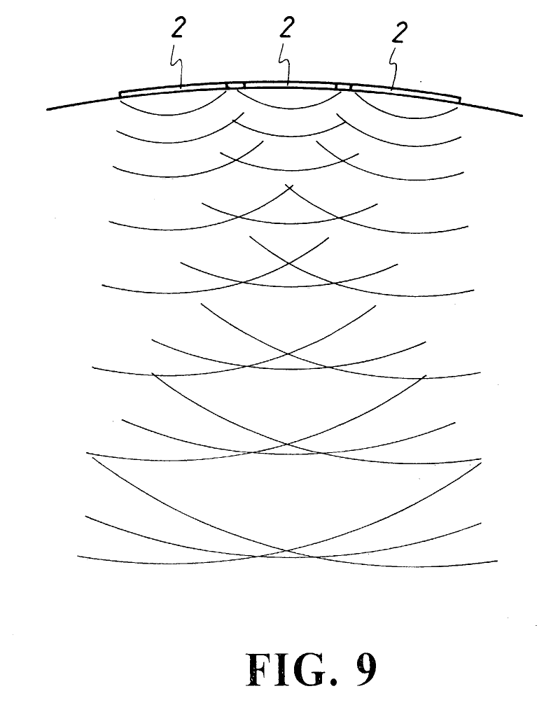

As shown in FIGS. 8 and 9, in use of the bio-wave device, the sticky pieces 2 are attached on the user's ache portion. Thus, when the multiple bio-waves coincide with and overlap the natural frequency of the human cell organism, the resonance absorbing effect is thus produced as shown in FIG. 9, so as to enhance immunity of the human body, and to develop the circulation of blood.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A bio-wave device, comprising:
a base member; and
a layer of bio-wave material attached on a surface of the base member and having a pre-determined shape.

2. The bio-wave device in accordance with claim 1, wherein the layer of bio-wave material is attached on the base member by a laser technology.

3. The bio-wave device in accordance with claim 1, wherein the layer of bio-wave material is made of a powdered or liquid element at least containing Ca, Ti, Cr, Ni, Cu, Pb, Mn, Fe and Zn.

4. The bio-wave device in accordance with claim 1, wherein the base member includes a hard card, and the layer of bio-wave material includes a thin layer attached on a surface of the hard card.

5. The bio-wave device in accordance with claim 1, wherein the layer of bio-wave material has a rectangular shape.

6. The bio-wave device in accordance with claim 1, wherein the base member includes a plurality of soft sticky pieces, and the layer of bio-wave material is attached on a surface of each of the sticky pieces.

7. The bio-wave device in accordance with claim 6, further comprising a protective film removably mounted on the sticky pieces to protect the sticky pieces.

8. The bio-wave device in accordance with claim 1, wherein the pre-determined shape of the layer of bio-wave material includes a plurality of discrete, spaced apart sections.

9. The bio-wave device in accordance with claim 1, wherein the pre-determined shape of the layer of bio-wave material includes a central portion and a plurality of spaced apart, arcuate strips around the central portion.

10. The bio-wave device in accordance with claim 1, wherein the pre-determined shape of the layer of bio-wave material includes a plurality of spaced apart, diagonal strips.

11. The bio-wave device in accordance with claim 1, wherein the base member includes a hard card; and
a plurality of soft sticky pieces removably attached to the hard card.

12. The bio-wave device in accordance with claim 11, further comprising a pulling tab located between the hard card and the sticky pieces to facilitate removable of the sticky pieces from the hard card.

13. The bio-wave device in accordance with claim 1 1, further comprising a plurality of separable lines formed between the sticky pieces, so that the sticky pieces can be torn away one by one.
